(19) United States
(12) Patent Application Publication
(10) Pub. No.: US 2018/0220322 A1
(43) Pub. Date: Aug. 2, 2018

(54) TECHNIQUES FOR HARDWARE-ASSISTED TRANSMISSION CONTROL PROTOCOL (TCP) SEGMENTATION OFFLOADING

(71) Applicant: Qualcomm Atheros, Inc., San Diego, CA (US)

(72) Inventors: Dhanashri Atre, Campbell, CA (US); Debashis Dutt, San Jose, CA (US); Rong He, San Diego, CA (US); James Cho, Mountain View, CA (US); Sungho Chang, San Diego, CA (US)

(21) Appl. No.: 15/421,226

(22) Filed: Jan. 31, 2017

(51) Int. Cl. H04W 28/02; H04L 29/12

(52) U.S. Cl. CPC H04W 28/02; H04W 84/12; H04L 61/6063

(57) ABSTRACT

A method, an apparatus, and a computer program product for wireless communication are provided. The apparatus may receive a threshold quantity of data for transmission via a network. The apparatus may perform a hardware-assisted transmission control protocol (TCP) segmentation offload procedure using software of the apparatus to determine metadata for a set of TCP packets and hardware of the apparatus to segment the threshold quantity of data into the set of TCP packets and to generate a TCP header for the set of TCP packets based at least in part on the metadata. The apparatus may transmit the set of TCP packets based at least in part on performing the hardware-assisted TCP segmentation offload procedure.

### BACKGROUND

### Field

The present disclosure relates generally to communication systems, and more particularly, to techniques for hardware-assisted transmission control protocol (TCP) segmentation offloading.

### Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a method, an apparatus, and a computer program product are provided.

In some aspects, the method may include receiving, by a wireless communication device, a threshold quantity of data for transmission via a network; performing, by the wireless communication device, a hardware-assisted transmission control protocol (TCP) segmentation offload procedure using software of the wireless communication device to determine metadata for a set of TCP packets and hardware of the wireless communication device to segment the threshold quantity of data into the set of TCP packets and to generate a TCP header for the set of TCP packets based at least in part on the metadata; and transmitting, by the wireless communication device, the set of TCP packets based at least in part on performing the hardware-assisted TCP segmentation offload procedure.

In some aspects, the apparatus may include a memory and at least one processor coupled to the memory. The at least one processor may be configured to receive a threshold quantity of data for transmission via a network. The at least one processor may be configured to perform a hardware-assisted TCP segmentation offload procedure using software of the apparatus to determine metadata for a set of TCP packets and hardware of the apparatus to segment the threshold quantity of data into the set of TCP packets and to generate a TCP header for the set of TCP packets based at least in part on the metadata. The at least one processor may be configured to transmit the set of TCP packets based at least in part on performing the hardware-assisted TCP segmentation offload procedure.

In some aspects, the apparatus may include means for receiving a threshold quantity of data for transmission via a network. The apparatus may include means for performing a hardware-assisted TCP segmentation offload procedure using software of the apparatus to determine metadata for a set of TCP packets and hardware of the apparatus to segment the threshold quantity of data into the set of TCP packets and to generate a TCP header for the set of TCP packets based at least in part on the metadata. The apparatus may include means for transmitting the set of TCP packets based at least in part on performing the hardware-assisted TCP segmentation offload procedure.

In some aspects, the computer program product may include a non-transitory computer-readable medium storing computer executable code for wireless communication. The computer program product may include code for receiving, by a wireless communication device, a threshold quantity of data for transmission via a network. The computer program product may include code for performing, by the wireless communication device, a hardware-assisted TCP segmentation offload procedure using software of the wireless communication device to determine metadata for a set of TCP packets and hardware of the wireless communication device to segment the threshold quantity of data into the set of TCP packets and to generate a TCP header for the set of TCP packets based at least in part on the metadata. The computer program product may include code for transmitting, by the wireless communication device, the set of TCP packets based at least in part on performing the hardware-assisted TCP segmentation offload procedure.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7 is a diagram illustrating an example of hardware-assisted TCP segmentation offloading.

FIG. 8 is a flow chart of a method of wireless communication.

FIG. 9 is a conceptual data flow diagram illustrating the data flow between different modules/means/components in an example apparatus.

FIG. 10 is a diagram illustrating an example of a hardware implementation for an apparatus employing a processing system.

### DETAILED DESCRIPTION

The detailed description set forth below in connection with the appended drawings is intended as a description of various configurations and is not intended to represent the configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

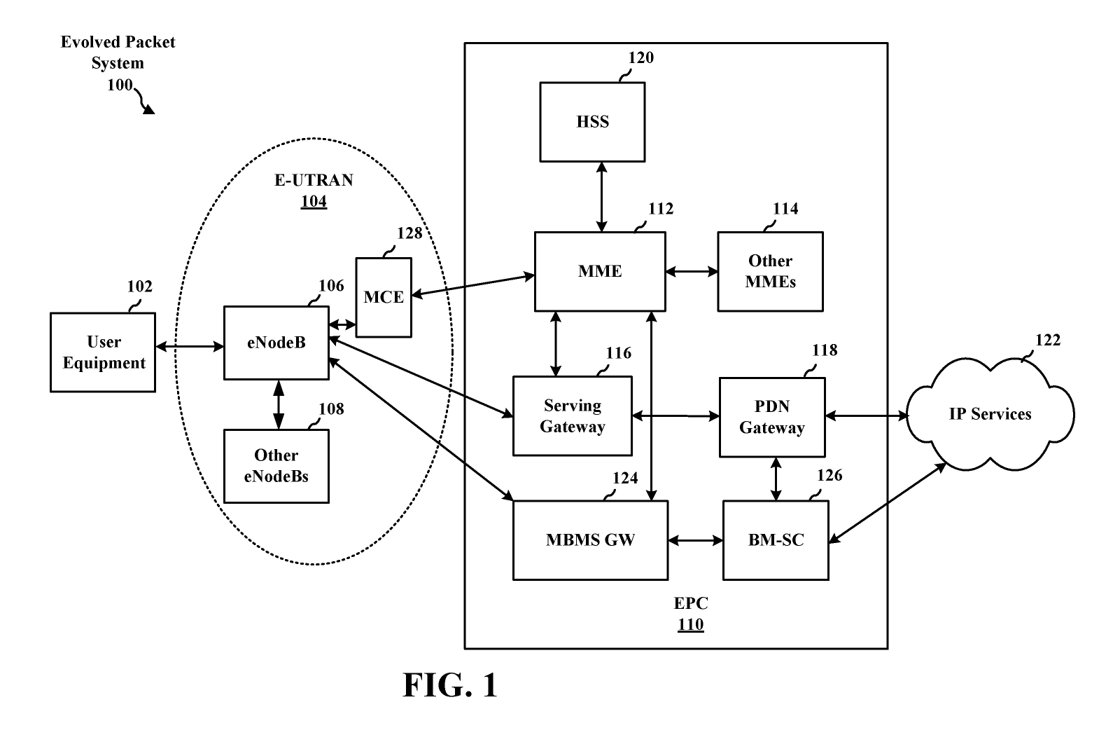

FIG. 1 is a diagram illustrating a Long Term Evolution (LTE) network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN 104 includes the evolved Node B (eNB) 106 and other eNBs 108, and may include a Multicast Coordination Entity (MCE) 128. The eNB 106 provides user and control planes protocol terminations toward the UE 102. The eNB 106 may be connected to the other eNBs 108 via a backhaul (e.g., an X2 interface). The MCE 128 allocates time/frequency radio resources for evolved Multimedia Broadcast Multicast Service (MBMS) (eMBMS), and determines the radio configuration (e.g., a modulation and coding scheme (MCS)) for the eMBMS. The MCE 128 may be a separate entity or part of the eNB 106. The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 may include a Mobility Management Entity (MME) 112, a Home Subscriber Server (HSS) 120, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 and the BM-SC 126 are connected to the IP Services 122. The IP Services 122 may include the Internet, an intranet, an IP Multimedia Subsystem (IMS), a PS Streaming Service (PSS), and/or other IP services. The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

FIG. 1 is provided as an example. Other examples are possible and may differ from what was described in connection with FIG. 1.

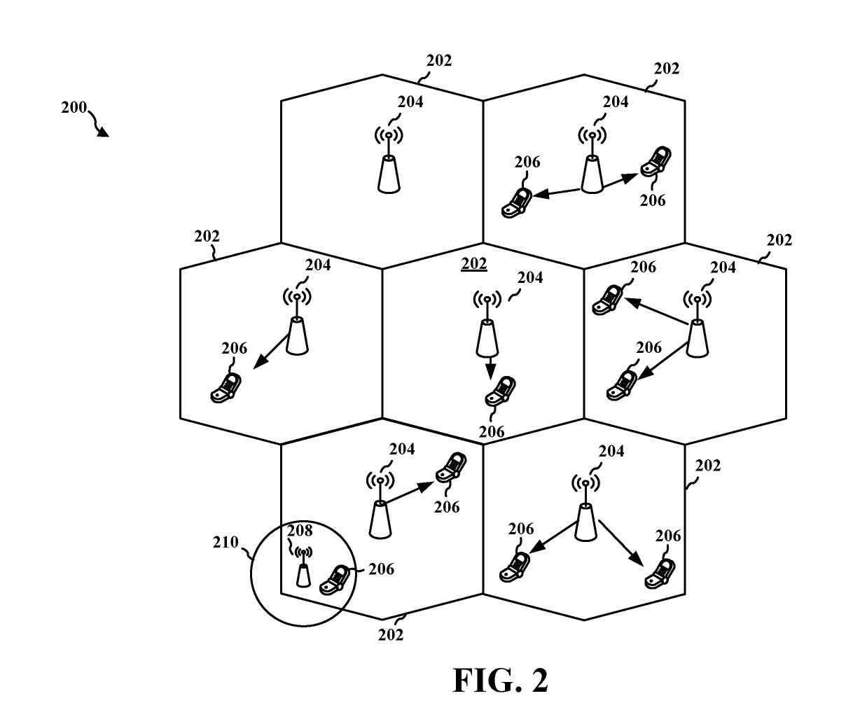

FIG. 2 is a diagram illustrating an example of an access network 200 in an LTE network architecture. In this example, the access network 200 is divided into a 164363 number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB 204 may support one or multiple (e.g., three) cells (also referred to as a sectors). The term “cell” can refer to the smallest coverage area of an eNB and/or an eNB subsystem serving a particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, orthogonal frequency-division multiplexing (OFDM) is used on the downlink (DL) and single-carrier frequency division multiple access (SC-FDMA) is used on the uplink (UL) to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

FIG. 2 is provided as an example. Other examples are possible and may differ from what was described in connection with FIG. 2.

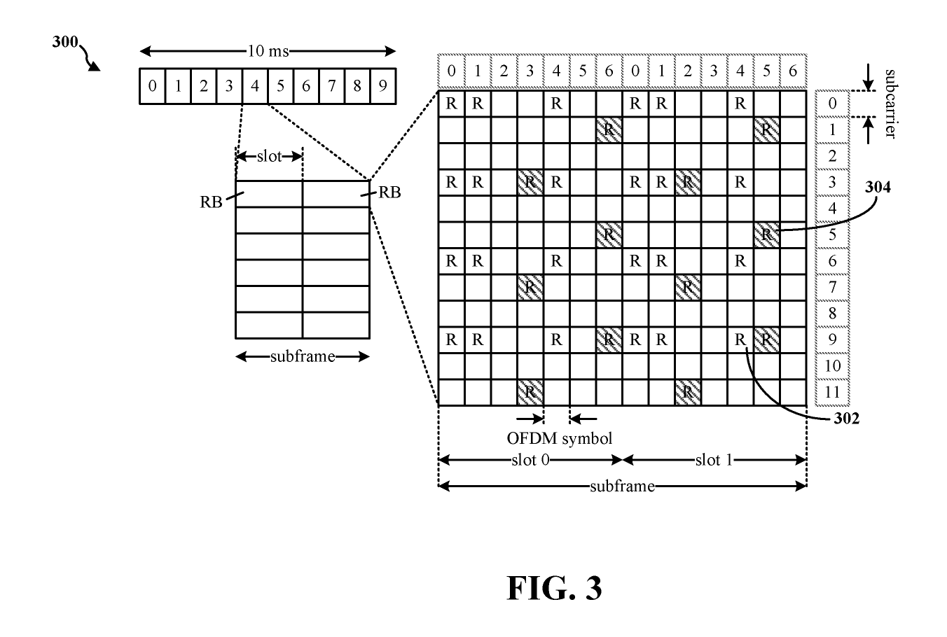

FIG. 3 is a diagram 300 illustrating an example of a DL frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, for a normal cyclic prefix, a resource block contains 12 consecutive subcarriers in the frequency domain and 7 consecutive OFDM symbols in the time domain, for a total of 84 resource elements. For an extended cyclic prefix, a resource block contains 12 consecutive subcarriers in the frequency domain and 6 consecutive OFDM symbols in the time domain, for a total of 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

FIG. 3 is provided as an example. Other examples are possible and may differ from what was described in connection with FIG. 3.

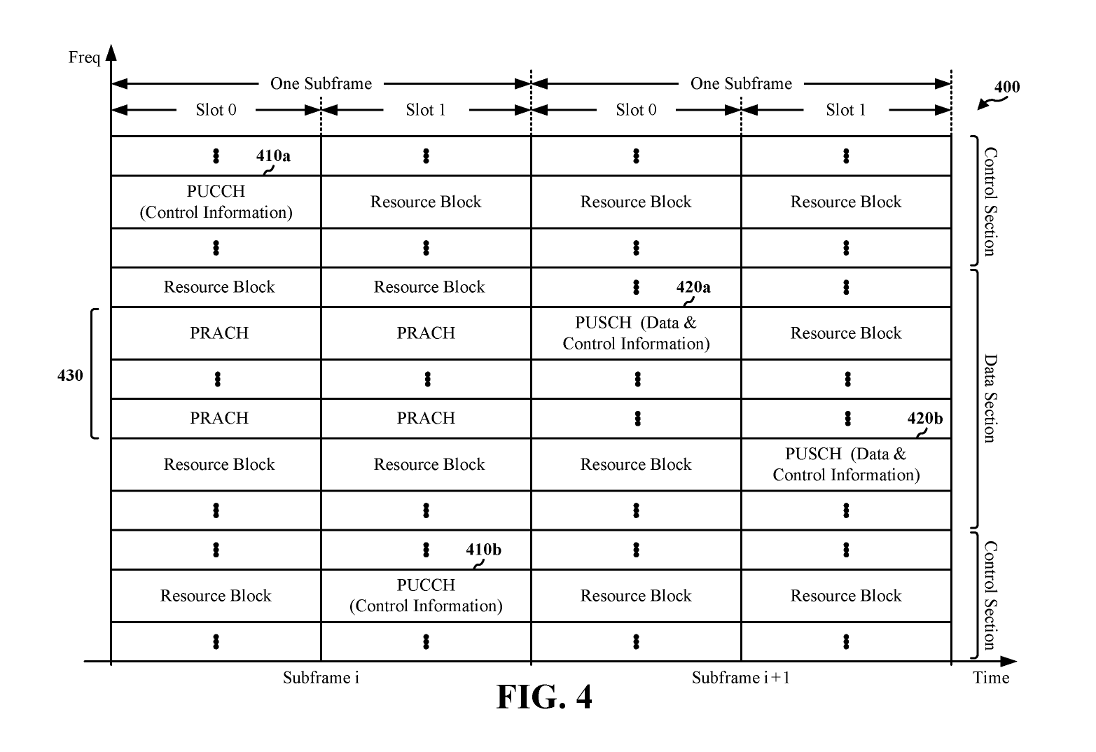

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make a single PRACH attempt per frame (10 ms).

FIG. 4 is provided as an example. Other examples are possible and may differ from what was described in connection with FIG. 4.

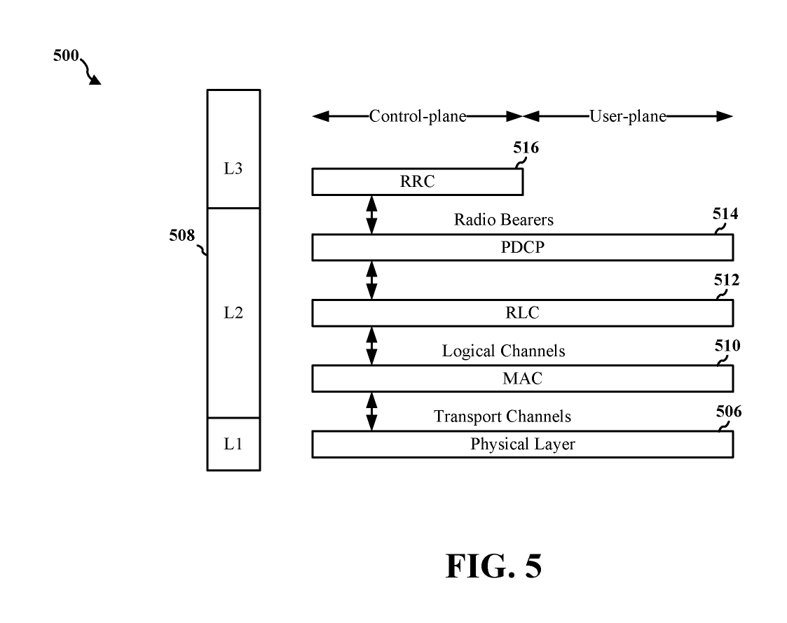

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (e.g., radio bearers) and for configuring the lower layers using RRC signaling between the eNB and the UE.

FIG. 5 is provided as an example. Other examples are possible and may differ from what was described in connection with FIG. 5.

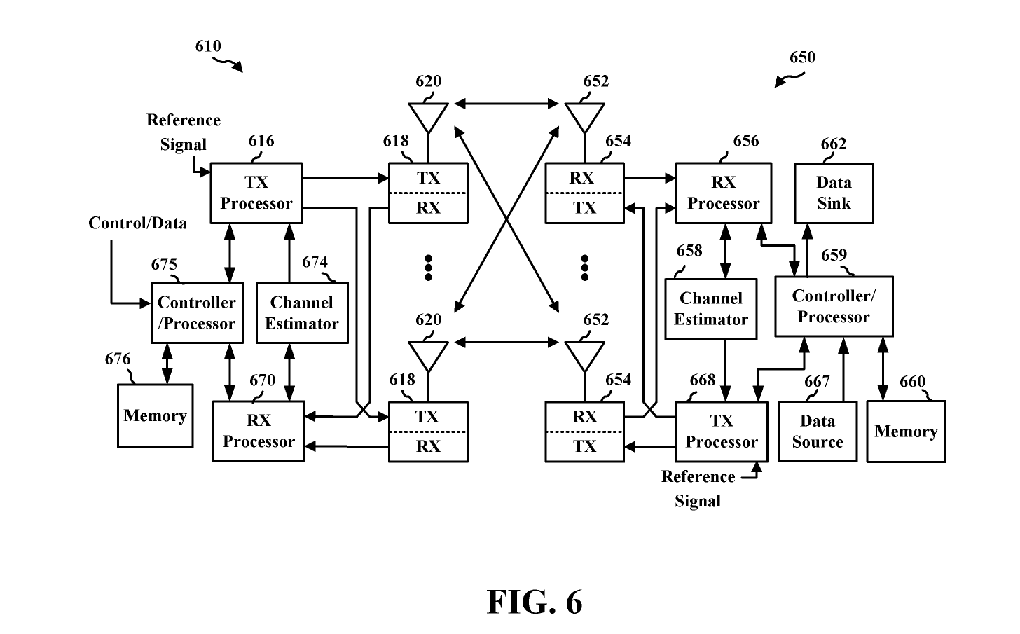

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based at least in part on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based at least in part on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618TX. Each transmitter 618TX may modulate a radio frequency (RF) carrier with a respective spatial stream for transmission.

At the UE 650, each receiver 654 RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 610. These soft decisions may be based at least in part on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based at least in part on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 may be provided to different antenna 652 via separate transmitters 654TX. Each transmitter 654TX may modulate an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the controller/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an acknowledgement (ACK) and/or negative acknowledgement (NACK) protocol to support HARQ operations.

FIG. 6 is provided as an example. Other examples are possible and may differ from what was described in connection with FIG. 6.

A wireless communication device may receive data for transmission via a network. For example, a set of applications of the wireless communication device may generate data that is to be provided as payload of a set of TCP packets. Based on the data satisfying a threshold associated with a maximum amount of data that can be included as payload of a particular TCP packet, the wireless communication device may segment the data into multiple TCP packets at the TCP layer using a software driver of the wireless communication device. However, segmenting the data using the software driver may require an excessive utilization of computing resources of the wireless communication device. As a result, the wireless communication device may perform TCP segmentation offloading, during which the wireless communication device may delay segmentation of TCP transmit packets from performance at the TCP layer of the network stack to a later point in the transmit path. However, TCP segmentation offloading may still require an excessive utilization of computing resources to generate TCP packet headers for each TCP packets.

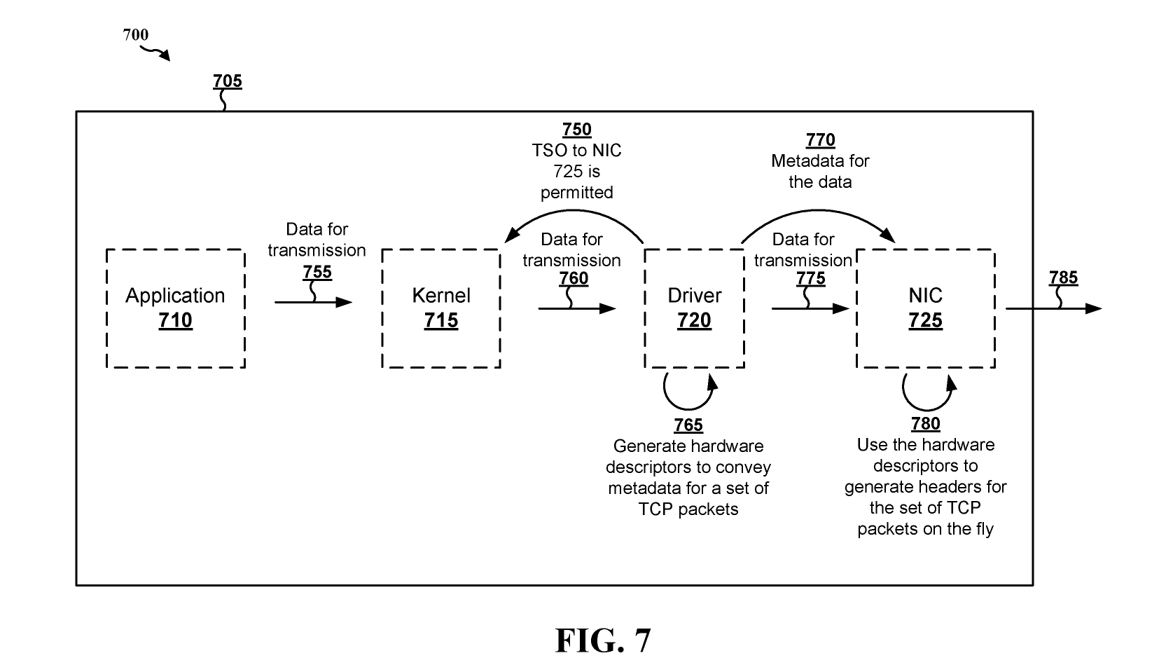

FIG. 7 is a diagram illustrating an example environment 700 including a wireless communication device 705 that performs hardware-assisted TCP segmentation offload. As shown in FIG. 7, wireless communication device 705 may include application(s) 710, a kernel 715, a driver 720, and a network interface card (NIC) 725.

As further shown in FIG. 7, and by reference number 750, driver 720 (e.g., a Wi-Fi software driver) may indicate to kernel 715 (e.g., a Linux kernel) that driver 720 supports TCP segmentation offload (TSO) to NIC 725 (i.e., a hardware component). TCP segmentation offload is sometimes referred to as TSO. Based at least in part on receiving the indication that driver 720 supports TCP segmentation offload, kernel 715 may determine that information may be passed to driver 720 for TCP segmentation offload and transmission by NIC 725.

As further shown in FIG. 7, and by reference number 755, a particular application 710 may provide data to kernel 715 for transmission via a network. For example, application 710 may provide a message for transmission to another wireless communication device, data for transmission to a server, or the like. In some aspects, the data may satisfy a data size threshold associated with the network, such as a data size threshold relating to a maximum transmission unit (MTU) size of the network. For example, application 710 may provide a particular quantity of data that is greater than a threshold size, and is to be segmented into a set of packets, which are each less than the threshold size. In some aspects, the data may be a jumbo packet of a jumbo TCP frame. As shown by reference number 760, kernel 715 may provide the data to driver 720 for transmission via a network.

As further shown in FIG. 7, and by reference number 765, driver 720 may determine metadata, and may generate hardware descriptors to convey metadata for a set of TCP packets that are to be transmitted via the network. In some aspects, driver 720 may determine the metadata for the set of TCP packets based at least in part on the data. For example, driver 720 may determine a TCP flag, an Internet Protocol identifier, a TCP sequence number, a length identifier (e.g., a TCP length identifier, an Internet Protocol length identifier, etc.), and/or the like. In some aspects, driver 720 may determine a set of physical addresses for a set of TCP segments corresponding to the data. For example, driver 720 may identify a set of non-contiguous memory locations identified by physical addresses for the data in memory and may configure the hardware descriptors to identify the physical addresses for the set of non-contiguous memory locations. As shown by reference number 770, driver 720 may provide the metadata from a TCP layer of a network stack (e.g., of driver 720) to the hardware of NIC 725 for use in segmenting the data into a set of TCP packets and/or generating a TCP header for the set of TCP packets. As shown by reference number 775, driver 720 provides the data to NIC 725 to cause NIC 725 to segment the data into the set of TCP packets and/or to cause NIC 725 to generate a TCP header for the set of TCP packets using hardware of NIC 725.

As further shown in FIG. 7, and by reference number 780, NIC 725 performs hardware-assisted TCP segmentation based at least in part on wireless communication device 705 offloading the TCP segmentation from software of driver 720 to hardware of NIC 725. In some aspects, NIC 725 may use metadata included in the hardware descriptors to segment the data into TCP packets. In some aspects, NIC 725 may use the metadata (e.g., the hardware descriptors) to generate TCP headers for the set of TCP packets. For example, NIC 725 may generate a TCP header on-the-fly (e.g., as each TCP packet is to be transmitted) to address the TCP packets for transmission. In this case, hardware of NIC 725 may identify a pointer to a payload of each TCP packet (e.g., segments of the data), obtain the payload of each TCP packet, and include the TCP header with each TCP packet as each TCP packet is sent via a network connection (e.g., an air interface) of NIC 725, as shown by reference number 785. In this way, wireless communication device 705 reduces utilization of processing resources and power utilization relative to another technique for wireless communication that does not include hardware-assisted TCP segmentation or another technique for TCP segmentation offload that does not include TCP headers generated on-the-fly based at least in part on metadata included in hardware descriptors.

As indicated above, FIG. 7 is provided merely as an example. Other examples are possible and may differ from what was described with regard to FIG. 7.

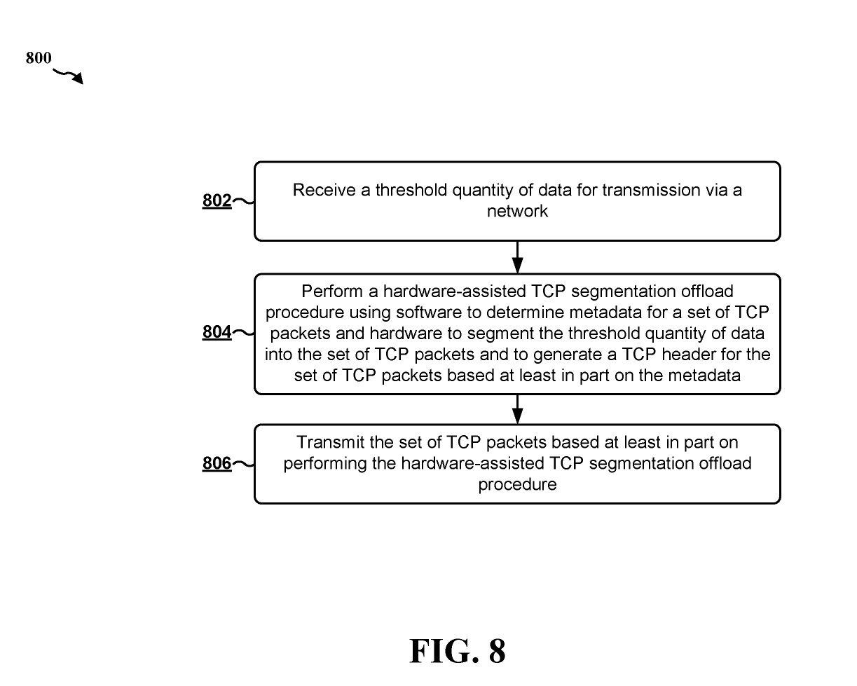

FIG. 8 is a flow chart 800 of a method of wireless communication. The method may be performed by a UE (e.g., the UE 102, the UE 206, the UE 650, the wireless communication device 705, the apparatus 902/902′).

At 802, the UE may receive a threshold quantity of data for transmission via a network.

In some aspects, the threshold quantity of data may exceed an MTU size. For example, the UE may receive, from an application of the UE, from another device, and/or the like, one or more jumbo packets exceeding an MTU size for the network, and may determine to segment the one or more jumbo packets into TCP packets for transmission.

At 804, the UE may perform a hardware-assisted TCP segmentation offload procedure using software to determine metadata for a set of TCP packets and hardware to segment the threshold of quantity of data into the set of TCP packets and to generate a TCP header for the set of TCP packets based at least in part on the metadata.

In some aspects, the UE may determine the metadata using software of the UE. For example, to perform the hardware-assisted TCP segmentation procedure, the UE may use a driver, such as a Wi-Fi driver, to set a hardware descriptor identifying a TCP flag, an IP identifier, a TCP sequence number, an IP length identifier, and/or the like for a TCP packet that is to be generated by hardware of the UE. In this case, the UE may provide the hardware descriptor from a TCP layer of a network stack to the hardware to permit the hardware to generate a TCP header for a set of TCP packets, to set TCP flags of a TCP packet, and/or the like.

In some aspects, the UE may segment the threshold quantity of data based at least in part on the metadata. For example, the UE may use a NIC to segment a jumbo TCP packet into a set of TCP packets (e.g., each of a smaller size than the jumbo TCP packet, each no greater in size than the MTU size, etc.). In this case, the UE may generate TCP headers for the set of TCP packets concurrently with transmitting the set of TCP packets via an air interface. For example, when a particular TCP packet is to be transmitted via the air interface, the UE may utilize a hardware descriptor to generate a TCP header for the TCP packet. In this way, the UE may improve network performance and may reduce a utilization of processing resources relative to generating each TCP header in software prior to the set of TCP packets being provided for transmission.

In some aspects, the UE may fill a TCP frame using the threshold quantity of data and based at least in part on the metadata. For example, the hardware of the UE may generate a set of TCP packets to fill a TCP frame, and may transmit the TCP frame via the network. In this case, the UE may identify a set of portions of the TCP frame, and may include one or more of the set of TCP packets in the set of portions of the TCP frame for transmission.

In some aspects, hardware of the UE may use scatter-gather to generate the set of TCP packets. For example, the UE may determine a set of non-contiguous memory locations identified by a set of physical addresses of the metadata, and may set a hardware descriptor to permit TCP headers to be generated for payload data at the set of non-contiguous memory locations. In this case, the hardware of the UE may use scatter-gather to obtain the payload for transmission as TCP packets.

In some aspects, the hardware of the UE may perform a checksum (e.g., a cyclic redundancy check) when performing hardware-assisted TCP segmentation offload. For example, hardware of the UE may support TCP checksum offload (e.g., offloading of the checksum from software to hardware), and may perform a checksum of the TCP packets to reduce errors and/or perform error correction for the set of TCP packets.

Finally, at 806, the UE may transmit the set of TCP packets based at least in part on performing the hardware-assisted TCP segmentation offload procedure.

For example, the UE may transmit the set of TCP packets via a network to convey the threshold quantity of data (e.g., to another wireless communication device, to an eNB, to another type of device).

Although FIG. 8 shows example blocks of a method of wireless communication, in some aspects, the method may include additional blocks, fewer blocks, different blocks, or differently arranged blocks than those shown in FIG. 8. Additionally, or alternatively, two or more blocks shown in FIG. 8 may be performed in parallel.

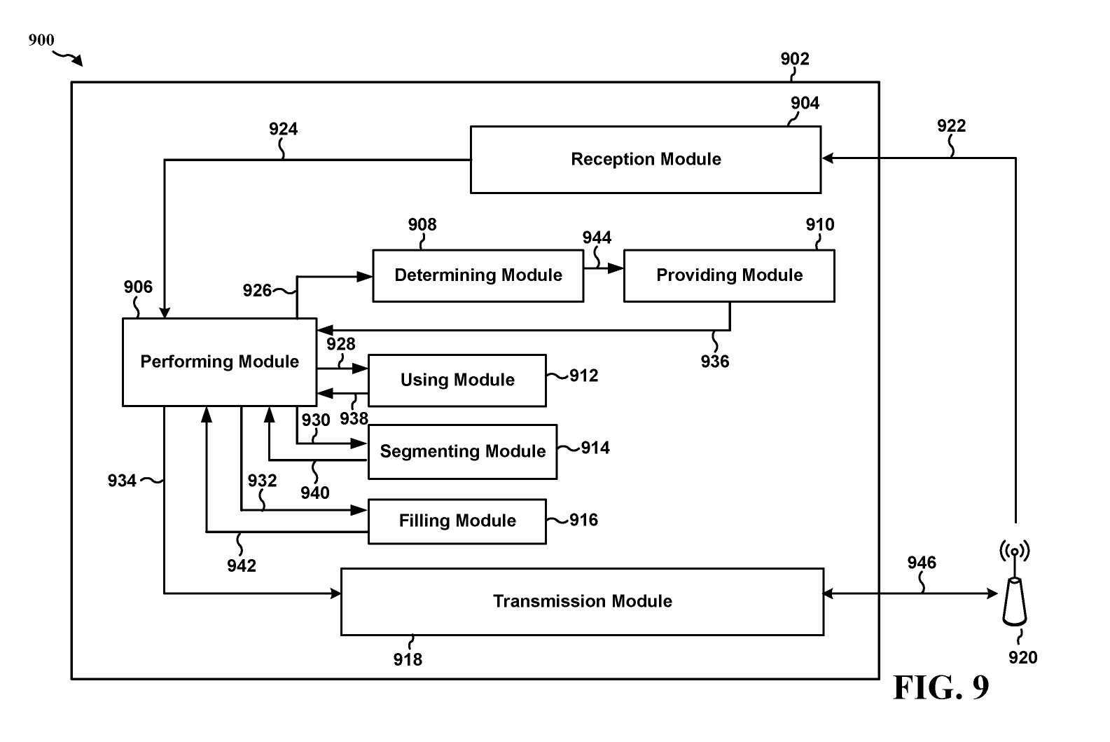

FIG. 9 is a conceptual data flow diagram 900 illustrating the data flow between different modules/means/components in an example apparatus 902. The apparatus 902 may be a UE. The apparatus 902 includes a reception module 904, a performing module 906, a determining module 908, a providing module 910, a using module 912, a segmenting module 914, a filling module 916, and a transmission module 918.

Reception module 904 may receive, from eNB 920, data 922, and may provide data 924 to performing module 906. In some aspects, reception module 904 may receive a threshold quantity of data 922 for transmission via a network. In some aspects, the threshold quantity of data exceeds the MTU size for the network.

Performing module 906 may receive data 924 from reception module 904, and may provide data 926 to determining module 908, data 928 to using module 912, data 930 to segmenting module 914, data 932 to filling module 916, and/or data 934 to transmission module 918. Additionally, or alternatively, performing module 906 may receive data 936 from providing module 910, data 938 from using module 912, data 940 from segmenting module 914, and/or data 942 from filling module 916.

In some aspects, performing module 908 may perform a hardware-assisted TCP segmentation offload procedure using software of the apparatus to determine metadata for a set of TCP packets and hardware of the apparatus to segment the threshold quantity of data into the set of TCP packets and to generate a TCP header for the set of TCP packets based at least in part on the metadata. In some aspects, the metadata may include a TCP flag, an IP identifier, a TCP sequence number, an IP length identifier, and/or the like. In some aspects the hardware may support scatter-gather and/or TCP checksum offload.

Determining module 908 may receive data 926 from performing module 906, and may provide data 944 to providing module 910. In some aspects, determining module 908 may determine, using a Wi-Fi driver, the metadata for the set of TCP packets.

Providing module 910 may receive data 944 from determining module 908, and may provide data 936 to performing module 906. In some aspects, providing module 910 may provide the metadata from a TCP layer of a network stack to the hardware based at least in part on determining the metadata.

Using module 912 may receive data 928 from performing module 906, and may provide data 938 to performing module 906. In some aspects, using module 912 may use a NIC to generate the TCP header. In some aspects, using module 912 may use a set of hardware descriptors to set one or more TCP flags of the metadata.

Segmenting module 914 may receive data 930 from performing module 906, and may provide data 940 to performing module 906. In some aspects, when the threshold quantity of data includes a jumbo packet, segmenting module 914 may segment the jumbo packet using the hardware (e.g., when the threshold quantity of data includes a jumbo packet).

Filling module 916 may receive data 932 from performing module 906, and may provide data 942 to performing module 906. In some aspects, filling module 916 may fill a TCP frame for transmission using the threshold quantity of data and based at least in part on the metadata.

Transmission module 918 may receive data 934 from performing module 906, and may provide data 946 to eNB 920. In some aspects, transmission module 918 may transmit the set of TCP packets based at least in part on performing module 906 performing the hardware-assisted TCP segmentation offload procedure.

The apparatus may include additional modules that perform each of the blocks of the algorithm in the aforementioned flow chart of FIG. 8. As such, each block in the aforementioned flow chart of FIG. 8 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

The number and arrangement of modules shown in FIG. 9 are provided as an example. In practice, there may be additional modules, fewer modules, different modules, or differently arranged modules than those shown in FIG. 9. Furthermore, two or more modules shown in FIG. 9 may be implemented within a single module, or a single module shown in FIG. 9 may be implemented as multiple, distributed modules. Additionally, or alternatively, a set of modules (e.g., one or more modules) shown in FIG. 9 may perform one or more functions described as being performed by another set of modules shown in FIG. 9.

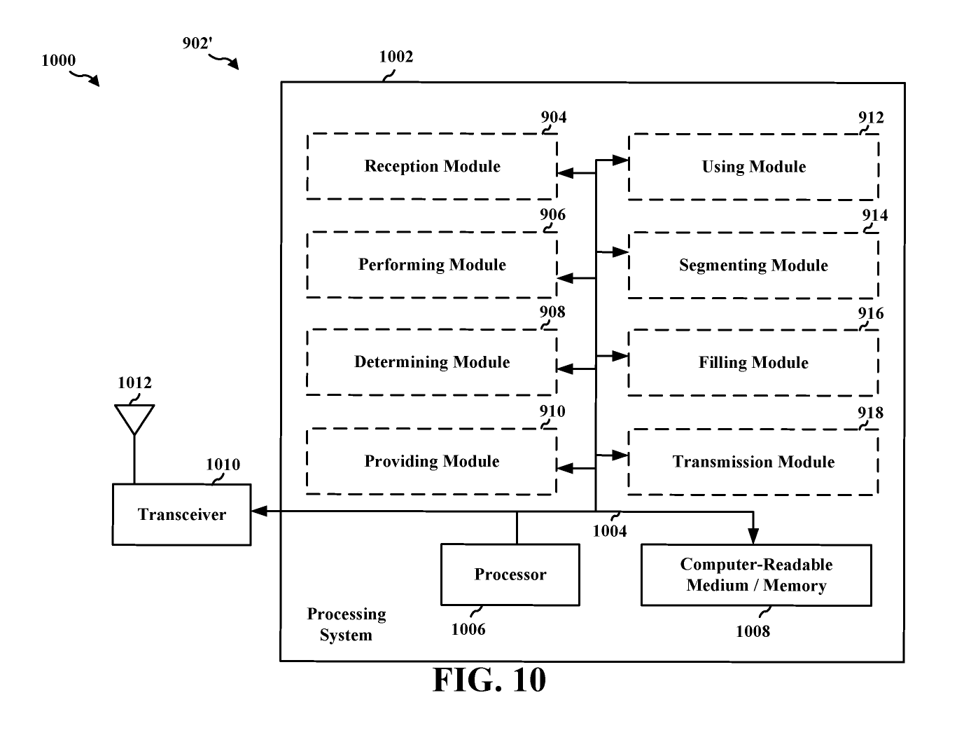

FIG. 10 is a diagram 1000 illustrating an example of a hardware implementation for an apparatus 902′ employing a processing system 1002. The apparatus 902′ may be a UE.

The processing system 1002 may be implemented with a bus architecture, represented generally by the bus 1004. The bus 1004 may include any number of interconnecting buses and bridges depending on the specific application of the processing system 1002 and the overall design constraints. The bus 1004 links together various circuits including one or more processors and/or hardware modules, represented by the processor 1006, the modules 904, 906, 908, 910, 912, 914, 916, and 918, and the non-transitory computer-readable medium/memory 1008. The bus 1004 may also link various other circuits such as timing sources, peripherals, voltage regulators, and power management circuits, which are well known in the art, and therefore, will not be described any further.

The processing system 1002 may be coupled to a transceiver 1010. The transceiver 1010 is coupled to one or more antennas 1012. The transceiver 1010 provides a means for communicating with various other apparatus over a transmission medium. The transceiver 1010 receives a signal from the one or more antennas 1012, extracts information from the received signal, and provides the extracted information to the processing system 1002, specifically the reception module 904. In addition, the transceiver 1010 receives information from the processing system 1002, specifically the transmission module 918, and based at least in part on the received information, generates a signal to be applied to the one or more antennas 1012. The processing system 1002 includes a processor 1006 coupled to a non-transitory computer-readable medium/memory 1008. The processor 1006 is responsible for general processing, including the execution of software stored on the non-transitory computer-readable medium/memory 1008. The software, when executed by the processor 1006, causes the processing system 1002 to perform the various functions described supra for any particular apparatus. The non-transitory computer-readable medium/memory 1008 may also be used for storing data that is manipulated by the processor 1006 when executing software. The processing system further includes at least one of the modules 906, 908, 910, 912, 914, or 916. The modules may be software modules running in the processor 1006, resident/stored in the non-transitory computer readable medium/memory 1008, one or more hardware modules coupled to the processor 1006, or some combination thereof. The processing system 1002 may be a component of the UE 650 and may include the memory 660 and/or at least one of the TX processor 668, the RX processor 656, and the controller/processor 659.

In some aspects, the apparatus 902/902′ for wireless communication includes means for receiving a threshold quantity of data for transmission via a network, means for performing a hardware-assisted TCP segmentation offload procedure using software of the apparatus to determine metadata for a set of TCP packets and hardware of the apparatus to segment the threshold quantity of data into the set of TCP packets and to generate a TCP header for the set of TCP packets based at least in part on the metadata, means for determining, using a Wi-Fi-driver, the metadata for the set of TCP packets, means for providing the metadata from a TCP layer of a network stack to the hardware based at least in part on determining the metadata, means for using a NIC to generate the TCP header, means for segmenting a jumbo packet of the threshold quantity of data using the hardware, means for filling a TCP frame for transmission using the threshold quantity of data and based at least in part on the metadata, means for using a set of hardware descriptors to set one or more TCP flags of the metadata, and/or means for transmitting the set of TCP packets based at least in part on performing the hardware-assisted TCP segmentation offload procedure. The aforementioned means may be one or more of the aforementioned modules of the apparatus 902 and/or the processing system 1002 of the apparatus 902′ configured to perform the functions recited by the aforementioned means. As described supra, the processing system 1002 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

FIG. 10 is provided as an example. Other examples are possible and may differ from what was described in connection with FIG. 10.

It is understood that the specific order or hierarchy of blocks in the processes/flow charts disclosed is an illustration of example approaches. Based upon design preferences, it is understood that the specific order or hierarchy of blocks in the processes/flow charts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication, comprising:
receiving, by a wireless communication device, a threshold quantity of data for transmission via a network;
performing, by the wireless communication device, a hardware-assisted transmission control protocol (TCP) segmentation offload procedure using software of the wireless communication device to determine metadata for a set of TCP packets and hardware of the wireless communication device to segment the threshold quantity of data into the set of TCP packets and to generate a TCP header for the set of TCP packets based at least in part on the metadata; and
transmitting, by the wireless communication device, the set of TCP packets based at least in part on performing the hardware-assisted TCP segmentation offload procedure.

2. The method of claim 1, wherein performing the hardware-assisted TCP segmentation offload procedure comprises:
determining, using a Wi-Fi driver, the metadata for the set of TCP packets; and
providing the metadata from a TCP layer of a network stack to the hardware based at least in part on determining the metadata.

3. The method of claim 1, wherein the metadata comprises at least one of:
a TCP flag,
an Internet Protocol identifier,
a TCP sequence number, or
an Internet Protocol length identifier.

4. The method of claim 1, wherein performing the hardware-assisted TCP segmentation offload procedure comprises:
using a network interface card (NIC) to generate the TCP header.

5. The method of claim 1, wherein the threshold quantity of data includes a jumbo packet; and
wherein performing the hardware-assisted TCP segmentation offload procedure comprises:
segmenting the jumbo packet using the hardware.

6. The method of claim 1, wherein performing the hardware-assisted TCP segmentation offload procedure comprises:
filling a TCP frame for transmission using the threshold quantity of data and based at least in part on the metadata.

7. The method of claim 1, wherein the threshold quantity of data exceeds a maximum transmission unit (MTU) size.

8. The method of claim 1, further comprising:
using a set of hardware descriptors to set one or more TCP flags of the metadata.

9. The method of claim 1, wherein the hardware supports scatter-gather and TCP checksum offload.

10. An apparatus for wireless communication, comprising:
a memory;
at least one processor coupled to the memory and configured to:
receive a threshold quantity of data for transmission via a network;
perform a hardware-assisted transmission control protocol (TCP) segmentation offload procedure using software of the apparatus to determine metadata for a set of TCP packets and hardware of the apparatus to segment the threshold quantity of data into the set of TCP packets and to generate a TCP header for the set of TCP packets based at least in part on the metadata; and
transmit the set of TCP packets based at least in part on performing the hardware-assisted TCP segmentation offload procedure.

11. The apparatus of claim 10, wherein the at least one processor, when performing the hardware-assisted TCP segmentation offload procedure, is configured to:
determine, using a Wi-Fi driver, the metadata for the set of TCP packets; and
provide the metadata from a TCP layer of a network stack to the hardware based at least in part on determining the metadata.

12. The apparatus of claim 10, wherein the metadata comprises at least one of:
a TCP flag,
an Internet Protocol identifier,
a TCP sequence number, or
an Internet Protocol length identifier.

13. The apparatus of claim 10, wherein the at least one processor, when performing the hardware-assisted TCP segmentation offload procedure, is configured to:
use a network interface card (NIC) to generate the TCP header.

14. The apparatus of claim 10, wherein the threshold quantity of data includes a jumbo packet; and
wherein the at least one processor, when performing the hardware-assisted TCP segmentation offload procedure, is configured to:
segment the jumbo packet using the hardware.

15. The apparatus of claim 10, wherein the at least one processor, when performing the hardware-assisted TCP segmentation offload procedure, is configured to:
fill a TCP frame for transmission using the threshold quantity of data and based at least in part on the metadata.

16. The apparatus of claim 10, wherein the threshold quantity of data exceeds a maximum transmission unit (MTU) size.

17. The apparatus of claim 10, wherein the at least one processor is further configured to:
use a set of hardware descriptors to set one or more TCP flags of the metadata.

18. A non-transitory computer-readable medium storing computer executable code for wireless communication, comprising code for:
receiving, by a wireless communication device, a threshold quantity of data for transmission via a network;
performing, by the wireless communication device, a hardware-assisted transmission control protocol (TCP) segmentation offload procedure using software of the wireless communication device to determine metadata for a set of TCP packets and hardware of the wireless communication device to segment the threshold quantity of data into the set of TCP packets and to generate a TCP header for the set of TCP packets based at least in part on the metadata; and
transmitting, by the wireless communication device, the set of TCP packets based at least in part on performing the hardware-assisted TCP segmentation offload procedure.

19. The non-transitory computer-readable medium of claim 18, wherein the code for performing the hardware-assisted TCP segmentation offload procedure comprises code for:
determining, using a Wi-Fi driver, the metadata for the set of TCP packets; and
providing the metadata from a TCP layer of a network stack to the hardware based at least in part on determining the metadata.

20. The non-transitory computer-readable medium of claim 18, wherein the metadata comprises at least one of:
a TCP flag,
an Internet Protocol identifier,
a TCP sequence number, or
an Internet Protocol length identifier.
